(19) United States
(12) Patent Application Publication
(10) Pub. No.: US 2015/0215280 A1
(43) Pub. Date: Jul. 30, 2015

(54) INTELLIGENT VIRTUAL GATEWAY

(71) Applicants: Sin-Min Chang, Shelton, CT (US); Santanu Das, Monroe, CT (US)

(72) Inventors: Sin-Min Chang, Shelton, CT (US); Santanu Das, Monroe, CT (US)

(73) Assignee: DOMANICOM CORPORATION, Newton, MA (US)

(21) Appl. No.: 14/556,434

(22) Filed: Dec. 1, 2014

Related U.S. Application Data
(60) Provisional application No. 61/910,406, filed on Dec. 1, 2013.
(60) Provisional application No. 62/084,679, filed on Nov. 26, 2014.

(51) Int. Cl. H04L 29/06; H04L 29/08; H04L 12/24

(52) U.S. Cl. CPC H04L 63/02; H04L 41/5022; H04L 67/12; H04L 63/10

(57) ABSTRACT

Embodiments of the present disclosure include a system for providing services in a secure way with guaranteed service and device level performance. Such embodiments include an intelligent gateway device having an intelligent gateway module for managing one or more internal resources and one or more external resources as well as an environment wrapper defining access privilege to a subset of the one or more internal resources and a subset of one or more external resources. Further such embodiments include a personal cloud computer server coupled to the intelligent gateway device, the personal cloud computer server configuring the intelligent gateway device with a system load (e.g. the total software loaded onto the intelligent gateway device, etc.) and configuration information [e.g. how many virtual machines are to be configured, memory size, processor speed, security levels and function, access privileges, etc.).

### CROSS-REFERENCE TO RELATED APPLICATIONS

The present application is related to and claims benefit under 35 U.S.C. §119(e) from U.S. Provisional Patent Application No. 61/910,406 filed on Dec. 1, 2013 and is related to and claims benefit under 35 U.S.C. §119(e) from U.S. Provisional Patent Application No. 62/084,679 filed on Nov. 26, 2014, the entire contents of each of U.S. Provisional Patent Application No. 61/910,406 and U.S. Provisional Patent Application No. 62/084,679 being incorporated herein by reference in their entireties.

### BACKGROUND

Service Providers are looking for new manner of service delivery in response to consumers' demand for having access to ‘any service, any time, and any place’. Consumers increasingly have needs for services from multiple service providers to ensure that they can be productive in whatever vocation or avocation they are pursuing in any place and any time. Their ‘WORLD’ is their ‘vocation or avocation environment’ which includes the equipment and tools they use as well as the access to physical resources like space and other appliances they require and enjoy.

Because of world-wide economic progress over last 20 years, the consumers are now more mobile than ever. It is very typical now a day to see an American business man in Shenzhen, China, trying to consummate a business deal in the middle of night as observing a Chinese banker trying to clinch a real estate deal in Manhattan early in the morning on a Friday before he catches his flight to Beijing. Both of these people need to be continuously ‘CONNECTED’ to their ‘Home Office’ in every sense of the term ‘CONNECTED’. They need to consult with the ‘Home Office’ colleagues over the telephone and they need access to all their resources, they normally have access to in their ‘Home Office’, even when they are either in Shenzhen or in Manhattan. In other words, their ‘WORLD’ needs to travel with them no matter where they are.

Service providers worldwide are increasingly dependent on enterprises, particularly the multinationals, for revenue and profitability growth. Managed communications (MCS) tailored to serve the need of enterprise customers represent more than 20% of a typical service provider's business. Market forecasts for MCS point to a rapid growth of 10 to 15% per year over the next five years, reaching more than $100 billion per year in revenue worldwide in 2012. Service providers recognize that this market presents them with the best opportunity for revenue and profitability growth and are enhancing their enterprise service offerings—and their business relationships—by adding high-value services across the MCS range: managed business communication, managed customer interaction and managed networking. We believe that increasingly the requirement will be not just for offering any communication service any place and any time but for creating a mobile and personalized work environment for the consumers so that his or her ‘WORLD’ can travel as he or she travels.

A framework for the ‘WORLD’ of a typical mobile consumer will be first developed with emphasis on specifying the requirements in terms of functions and features including security and management attributes. A recent IBM report very aptly notes the fact that many of today's innovations are driven by the consumer marketplace, and the workplace is no exception. “As consumers, we are very familiar with new ways for people to find each other, keep in touch, share ideas and be mobile, getting information from any place, any time. As employees, we would like to apply these consumer capabilities to our work—seamlessly and on a global basis—to make us more productive and effective with business colleagues, clients and business partners.”

Organizations can expect to see several trends over the next few years relating to work and workplace communications. These include: (a) Employees spending the majority of their workday collaborating, (b) Increasing numbers of employees working remotely and “on the go”, (c) Accelerating employee expectations for ubiquitous access, video communications and social collaboration, (d) Employee desire to “bring your own device” (BYOD), using their device of choice for both personal and business use. This BYOD trend is very similar to the industrial environment which existed before the industrial revolution when workers, whether they are masons or carpenters, used to carry their own personalized tools to their work place, (e) Community collaboration superseding organizational structures.

Even with these workplace changes, IBM Report emphasizes the fact that one factor remains fundamental: people will continue to rely on voice and visual communication as the foundation of work and collaboration. In a globally integrated enterprise, it also becomes critical that employees have access to a common set of unified communications capabilities that bring together voice, video, data and social tools.

While the IBM Report, referred to earlier, deals with the communication and collaboration needs of a modern organization, a study initiated by SAIC (a San Diego based defense contractor) emphasizes the fact that in addition to having a state of the art communication infrastructure, organizations, today, need also to make sure that the IT infrastructure and technologies they use are also state of the art. Most of the enterprises today are putting emphasis on “technology initiatives across the enterprise to stay competitive and to improve their organizational and business agility; to manage ever growing volumes of structured and unstructured information; to meet complex compliance and content management requirements; to evolve business operations into a more streamlined and efficient shared services model; and to provide new service delivery channels to more demanding and knowledgeable consumers.”

According to SAIC studies, across all industries, advanced approaches to Customer Relationship Management (CRM), Supply Chain Management, and e-Commerce applications are enabling organizations to improve order accuracy and fulfillment, reduce processing costs, and expand personalized service to strengthen customer retention. In addition, advances in Enterprise Resource Planning (ERP) applications (more modular and often delivered over the Internet) and knowledge management systems are providing new tools to improve business performance and increase employee productivity.

This infusion and proliferation of new technology must be supported by an integrated, reliable, and scalable infrastructure to achieve desired business benefits, control costs, and ultimately avoid IT failures. As a result, this is radically altering information use and requirements.

Executives need timely access to the right information to analyze results from across the company to resolve problems and allocate resources. Independent departments must share information and expertise to leverage knowledge and resources and to bring new products to market quickly. Employees need to share information with remote offices, mobile employees, and external partners, suppliers, and customers.

It is obvious that a key foundation of a consumer's ‘WORLD’ is the unified communication capability he or she needs as he or she travels around the world. The other key component of he or her ‘WORLD’ is the IT infrastructure he or she enjoys while he or she is at his or her work environment, be it his or her office or home. This IT infrastructure needs to travel with the consumer who is now a days always on the go and always MOBILE.

The existing approach to meet the MOBILE need of consumers is to use a combination of Virtual Private Network (VPN) and deployment of server functions in the CLOUD. The VPN allows the mobile consumer a link to the enterprise resource at HOME (main office or residence) and having IT resources in the cloud allows the access to most of the needed IT infrastructure. However, this approach lacks integration of communication and IT infrastructure and because of bandwidth limitation of the VPN connection, the latency and throughput requirement needed for proper work environment while a consumer is away from HOME cannot be met. The other deficiency stems for the fact that the new environment is not known a priori to the management system in the cloud or the management system in the HOME office enterprise server.

What are needed are (a) a tight integration of communication and IT infrastructure in such a way that the integration benefits are available no matter whether the consumer is at HOME or in a remote place, and (b) the environment the consumer has access to in the remote place gets ‘Discovered’ automatically or on demand and gets integrated into the communication and IT infrastructure defined for the consumer in his or her ‘Home Environment’ so that the consumer can pursue his or her vocation or avocation using almost all the resources of his or her ‘WORLD’.

Accordingly, there is a need for an intelligent virtual gateway.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an Information and Communication Technology (ICT), in accordance with some embodiments.

FIG. 2 is a block diagram of an Information and Communication Technology (ICT), in accordance with some embodiments.

FIG. 3 is a block diagram of a network, in accordance with some embodiments.

FIG. 4 is a block diagram of an intelligent virtual gateway, in accordance with some embodiments.

FIG. 5 is a block diagram of management and administration of intelligent virtual gateways, in accordance with some embodiments.

FIG. 6 is a flowchart of a method 100 for providing services in a secure way with guaranteed service and device level performance, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the disclosure. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts, and accompanying written description. While these details are helpful to explain one or more embodiments, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure include a system for providing services in a secure way with guaranteed service and device level performance. Such embodiments include an intelligent gateway device having an intelligent gateway module for managing one or more internal resources and one or more external resources as well as an environment wrapper defining access privilege to a subset of the one or more internal resources and a subset of one or more external resources. Further such embodiments include a personal cloud computer server coupled to the intelligent gateway device, the personal cloud computer server configuring the intelligent gateway device with a system load (e.g. the total software loaded onto the intelligent gateway device, etc.) and configuration information [e.g. how many virtual machines are to be configured, memory size, processor speed, security levels and function, access privileges, etc.). The personal cloud server and the intelligent gateway device combination provides traditional services, and Internet of Things (IoT) services, and a secure premises environment such that traditional services, Internet of Things (IoT) services and secure premises environment are accessible from at least one of a remote location and a premises location. In addition, the intelligent gateway device is coupled to one or more internal interfaces, each internal interface corresponding to an internal resource, and one or more external interfaces, each external internal interface corresponding to an external resource. Moreover, the intelligent gateway module includes at least one of: (a) one or more virtual machine modules; (b) a common security layer module; (c) privilege descriptor module; (d) virtualizer module; (e) a process container module; (f) an application module. A process container includes an application and its dependencies. Further, a process container runs as an isolated processes in userspace on the host operating system, sharing the kernel with other process container modules. Thus, the process container enjoys the resource isolation of virtual machines but is much more portable and efficient. Each virtual machine may include not only the application and the necessary binaries and libraries but also an entire guest operating system. The one or more internal resources include at least one of a printer, television, video disc player, computer, smartphone, tablet, scanner, networked storage, surveillance camera, networked vehicle, sensor and appliance. The one or more external resources include at least one of a cloud storage, an external computing service, software as a service, external platform as a service, infrastructure as a service, information technology services and other intelligent gateway devices. The intelligent gateway module includes a guest user access sub-module and a configurable guest environment wrapper defining guest access privilege to a subset of the one or more internal resources and a subset of one or more external resources. Embodiments include a guest intelligent gateway device coupled to the personal cloud computer server having a guest intelligent gateway module generated by the guest gateway device based on the system load and instructions received from the personal cloud computer server wherein the instructions are based on the configuration information of the intelligent gateway module such that the guest intelligent gateway module manages at least the subset of one or more internal resources available locally and a subset of one or more external resources accessible to intelligent gateway device. At least one of intelligent gateway module and guest intelligent gateway module manages at least one of privacy and security based on at least one of a device level and service level service agreement using the intelligent gateway device. A device level agreement or priority is such that a device such data flowing to and from a mobile device is prioritized over land-line devices in a secure premises environment. A router within the secure premises environment may be configured to implement such device level agreements or priorities.

Embodiments of the present disclosure include a method for providing services in a secure way with guaranteed service and device level performance. Embodiments of the method include managing, by an intelligent gateway module on an intelligent gateway device, one or more internal resources and one or more external resources. The method further includes generating, by the intelligent gateway module on an intelligent gateway device, an environment wrapper. In addition, the method includes defining, by the environment wrapper, access privilege to a subset of the one or more internal resources and a subset of one or more external resources. Also, the method includes configuring, by a personal cloud computer server coupled to the intelligent gateway device, the intelligent gateway device with a system load and configuration information as described herein.

The personal cloud server and the intelligent gateway device combination provides traditional services, and Internet of Things (IoT) services, and a secure premises environment such that traditional services, Internet of Things (IoT) services and secure premises environment are accessible from at least one of a remote location and a premises location. The intelligent gateway device is coupled to one or more internal interfaces, each internal interface corresponding to an internal resource, and one or more external interfaces, each external internal interface corresponding to an external resource. The intelligent gateway module includes, as described herein, at least one of: (a) one or more virtual machine modules; (b) a common security layer module; (c) privilege descriptor module; (d) virtualizer module; (e) a process container module; (f) an application module. The one or more internal resources include at least one of a printer, television, video disc player, computer, smartphone, tablet, scanner, networked storage, surveillance camera, networked vehicle, sensor and appliance. The one or more external resources include at least one of a cloud storage, an external computing service, software as a service, external platform as a service, information technology services and other intelligent gateway devices. The intelligent gateway module includes a guest user access sub-module and a configurable guest environment wrapper defining guest access privilege to a subset of the one or more internal resources and a subset of one or more external resources. A guest intelligent gateway device is coupled to the personal cloud computer server including a guest intelligent gateway module generated by the guest gateway device based on the system load and instructions received from the personal cloud computer server wherein the instructions are based on the configuration information of the intelligent gateway module such that the guest intelligent gateway module manages at least the subset of one or more internal resources available locally and a subset of one or more external resources accessible to intelligent gateway device. At least one of intelligent gateway module and guest intelligent gateway module manages at least one of privacy and security based on at least one of a device level and service level service agreement both of which as described herein.

Embodiments of the present disclosure include a personal cloud computer server device for providing services in a secure way with guaranteed service and device level performance. The personal cloud computer server device including: (a) one or more processors; (b) one or more storage devices coupled to the one or more processors; (c) one or more modules, implemented by one or more processors, including a personal cloud computer server module coupled to an intelligent gateway device. The personal cloud computer server module configuring the intelligent gateway device with a system load and configuration information both of which described herein. The personal cloud computer server device and the intelligent gateway device combination provides traditional services, and Internet of Things (IoT) services, and a secure premises environment such that traditional services, Internet of Things (IoT) services and secure premises environment are accessible from at least one of a remote location and a premises location.

The intelligent gateway device is coupled to one or more internal interfaces, each internal interface corresponding to an internal resource, and one or more external interfaces, each external internal interface corresponding to an external resource. The one or more internal resources include at least one of a printer, television, video disc player, computer, smartphone, tablet, scanner, networked storage, surveillance camera, networked vehicle, sensor and appliance.

The one or more external resources include at least one of a cloud storage, an external computing service, software as a service, external platform as a service, information technology services and other intelligent gateway devices.

The personal cloud computer server module provides and the system load instructions to a guest intelligent gateway module on a guest intelligent gateway module device wherein the instructions are based on the configuration information if the intelligent gateway module such that the guest intelligent gateway module manages at least the subset of one or more internal resources available locally and a subset of one or more external resources accessible to intelligent gateway device.

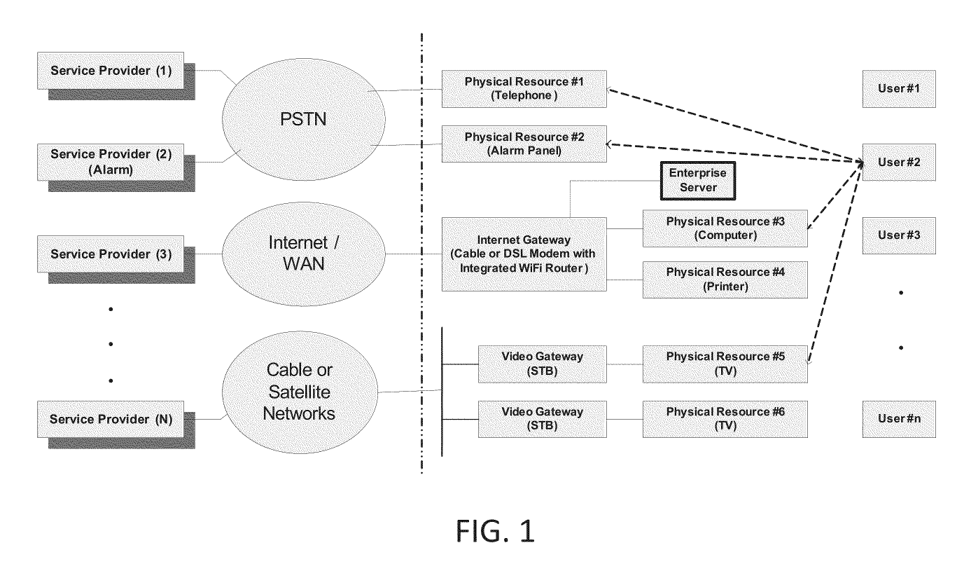

FIG. 1 is a block diagram of an Information and Communication Technology (ICT), in accordance with some embodiments. Further, FIG. 1 depicts a typical Enterprise Information and Communication Technology (ICT) environment. As can be seen, the voice services and data services are in most cases not integrated even when the two services are provided by the same service provider. The IT resources are either resident in the Enterprise Server or in the Cloud and are accessed using the Internet pipe terminating at the Enterprises' location or consumer's home. Most large enterprises have two separate functions managing the communication and the IT infrastructure needs. This environment obviously cannot travel with the MOBILE consumers in an integrated fashion.

Limited access to the HOME communication infrastructure and the IT infrastructure is possible using VPN type of approach but it is nowhere near the capability needed by today's MOBILE consumer who is always on the go.

While the FIG. 1 depicts the enterprise environment, the environment in the residence of the consumer is very similar excepting the fact that the resources available are more limited.

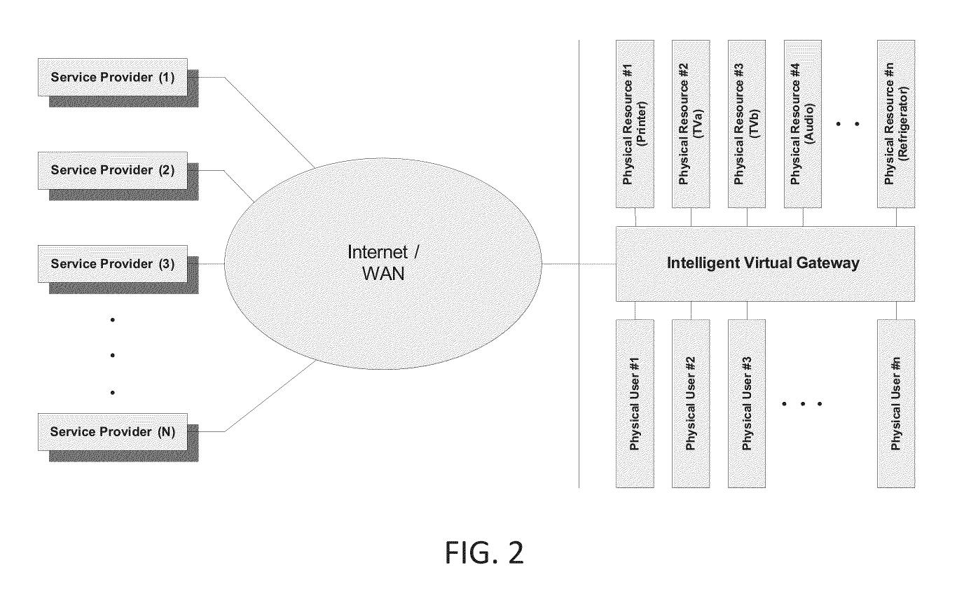

FIG. 2 is a block diagram of an Information and Communication Technology (ICT), in accordance with some embodiments. The ICT environment is depicted in FIG. 2 has the following salient features. The access for communication with the outside is integrated at the enterprise or at home. In most applications, voice, data, and video services will be provided by the same service provider (e.g. a cable TV service provider). An ‘Intelligent Virtual Gateway’ will coordinate and manage all resources in the enterprise or at home and would also manage access to outside resources. Multiple service providers will provide services to users at home or in the enterprise using the functions and features of the Intelligent Virtual Gateway. The Intelligent Virtual Gateway (IVG) will ensure and enforce service isolation among different services and service providers in a way such that from the user's point of view, the environment will be totally integrated and seamless. The IVG will guarantee privacy and security based on a Service Level Agreement (SLA). For a certain user, highest level of security may be needed and the environment wrapper may define the security level of the user accordingly. Moreover, the computing and memory resources expended for such a user will be higher than one who needs lower level of security. Similar paradigm applies to privacy. The intelligent virtual gateway is design in such a way that the user can define priority based on a particular service user fells to be more important than other services. For example, video streaming services like Netflix may be assigned higher priority than access to email or similar services. The user may also assign higher priority to a particular device compare to another device. Each user at the enterprise or at home will have his or her environment ‘DEFINED’ using an Environment Wrapper which would be user specific. This environment definition will travel with the user just like a passport of a traveler. Just like a passport has different privileges (a diplomat has more privileges than a common traveler), this traveling environment definition for a particular person would carry his or her privilege information no matter where the user is. The most of the IT resources are assumed to be in the cloud(s) for cost effectiveness as well as easy access from any place any time. The intelligent Gateway is implemented using a standard hardware and software platform (e.g. x86, ARM, or MIPS and Linux or Windows). Each user has an associated Intelligent Virtual Gateway running in the intelligent gateway of the enterprise. This IVG which runs on a standard platform and is implemented using virtual machines. In general, each virtual machine will be associated with one service provider which would provide one or more services. The Environment Wrapper referred to in (g) is associated with a user specific IVG. An image of the IVG is resident in the cloud so that it can be on the fly downloaded in a ‘Guest’ resource when the user is in an environment outside the HOME. The ‘Guest’ resource could be a public shared Hotspot or a node in the Guest Network.

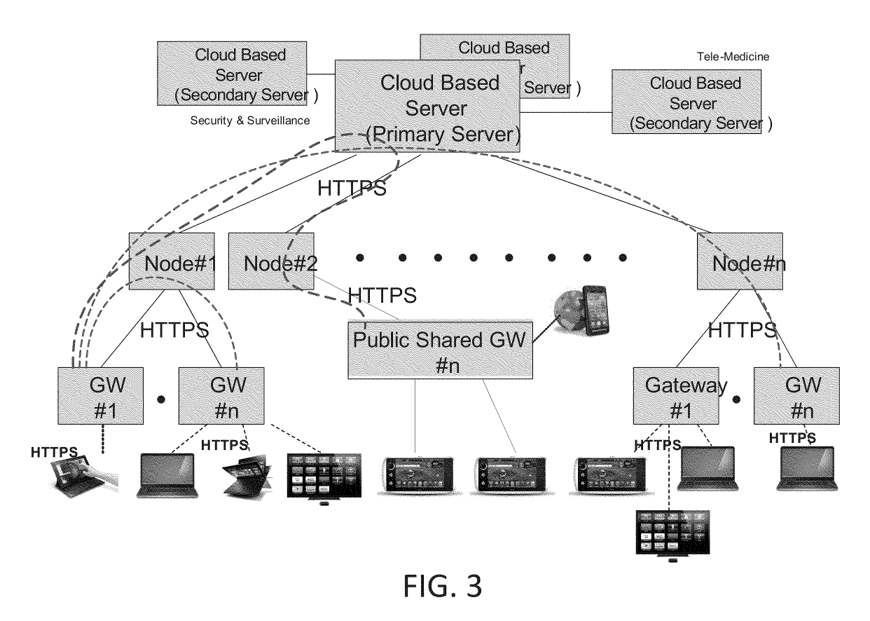

FIG. 3 is a block diagram of a network, in accordance with some embodiments. FIG. 3 shows a network architecture. The key features of this architecture are the following. The gateway (GW) in enterprise or home environment are controlled and managed by the primary service provider using a server in the cloud (Primary Server). This service provider might provide voice, data, and video services as is done today in USA by service providers like Verizon or AT&T. The primary service provider allows Secondary Service Providers to provide secondary services under managed environment to provide secondary services. The examples of the secondary services are security and surveillance, tele-medicine, energy management, IT services corresponding to the IT infrastructure and functions subscribed by the consumer or consumer's parent enterprise. The nodes in FIG. 3 are part of the service provider's infrastructure and they provide access to the network wide resources. They also do the caching and proxy server functions to ensure that the consumer enjoys an acceptable SLA. This network architecture allows a user to have access to resources under the purview of other nodes and gateways assuming that the user has subscribed to such access privileges and the associated Environment Wrapper defines such privileges. If the user migrates from the domain of one node/gateway pair to another node/gateway pair, the user's IVG function can be created on the fly in the new gateway (e.g. in the Gateway of a hotel) or in a public gateway. This IVG function gets loaded from the primary service provider's cloud to the ‘Guest’ gateway. The Environment Wrapper travels with the MOBILE user in his or her mobile device. This is similar to having Skype application in a PC which would allow a Skype call anywhere in the world as long as there is an Internet access. The Environment Wrapper will allow the cloud to either automatically DISCOVER the new environment or prompt the user to define the new environment. Obviously, in the Guest environment, not all the physical resources available at ‘HOME’ environment will be available. For instance, if the enterprise or home has sensors for environmental control, these sensors are not going to travel with the consumer. However, the consumer should be able to monitor their status and manage them no matter where the consumer is. Physical resources like printers, scanners, etc. are not going to similarly travel but the consumer should be able to define and include similar resource available in the Guest environment in his or her new environment using the resources of the Environment Wrapper. The requirement is to be able to remotely manage all resources in the enterprise or at home and to be able to define and include new similar or dissimilar resources in the Guest environment.

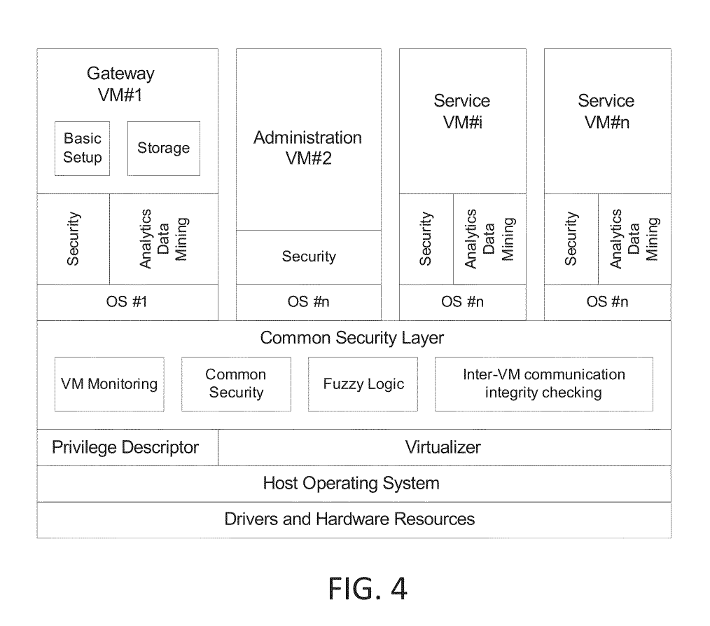

FIG. 4 is a block diagram of an intelligent virtual gateway, in accordance with some embodiments. Note, any function disclosed in the present disclosure are implemented by modules and processors. The FIG. 4 shows the architecture of the IVG. The key attributes of this architecture are as follow. Each IVG is associated with an End-User. Thus if an enterprise or a household has N number of End-Users, there will be N such IVG silos (a set of virtual machines and possibly some common functions) in the Intelligent Gateway (IG). Of course, there will be some common functions in the IG in addition to the IVG silos. Each IVG has a virtualized architecture with a few common virtual machines, namely Gateway virtual machine and Admin virtual machine which get generated during IVG initialization phase. In addition to the common virtual machines, there are service specific virtual machines which allow the end user to access different services and resources associated with those services. For instance, one virtual machine, VM#i in FIG. 4, could be associated with Enterprise Resource Planning (ERP) function with ERP service provided by a service provider using Software as a Service (SaaS) scheme. The VM#i in this context is the front-end of the ERP function; the most of ERP intelligence is resident in the cloud. Similarly, VM#n could be associated with Tele-Medicine service where VM#n is the front-end. The virtualized architecture along with the common security functions (e.g. in the common security layer implemented by modules) enforces separation of one service from others. The Gateway VM and the Admin VM both have security functions (e.g. implemented by modules) based on one of crisp logic and fuzzy logic. Similarly, the common security function is based on one of crisp logic and fuzzy logic. Each service VM can include service specific security functions based on one of crisp logic and fuzzy logic. The Gateway VM in FIG. 4 is used for communicating with the outside network environment and also used for location identification and environment discovery. If the Gateway VM needs any assistance from the End-User, the End-User shall be able to provide information via a dialog tool using his or her preferred device. The Admin VM in FIG. 4 is used to create the WORLD the End-User needs to be productive in pursuing his or her vocation or avocation. The Admin VM would communicate with the Primary Server to obtain a copy of the subscribed and provisioned Environment Wrapper; it would obtain the location and environment information from the Gateway VM and would configure the Gateway VM and other databases including the Privilege Descriptor to recreate the End-User's WORLD. The preceding steps are used to create the IVG for each End-User within the IG. If any End-User travels outside the domain of his or her associated home IG, the preceding steps are invoked by the mobile End-User by logging into the Primary Service Provider's Primary Server and a replica of the End-User's IVG gets created in a Guest IG. The Guest IG could be a public IG as shown in FIG. 3 or any other IG to which the End-User can gain access to. The End-User's mobile device would have specialized application software (App) to log into the Primary Server.

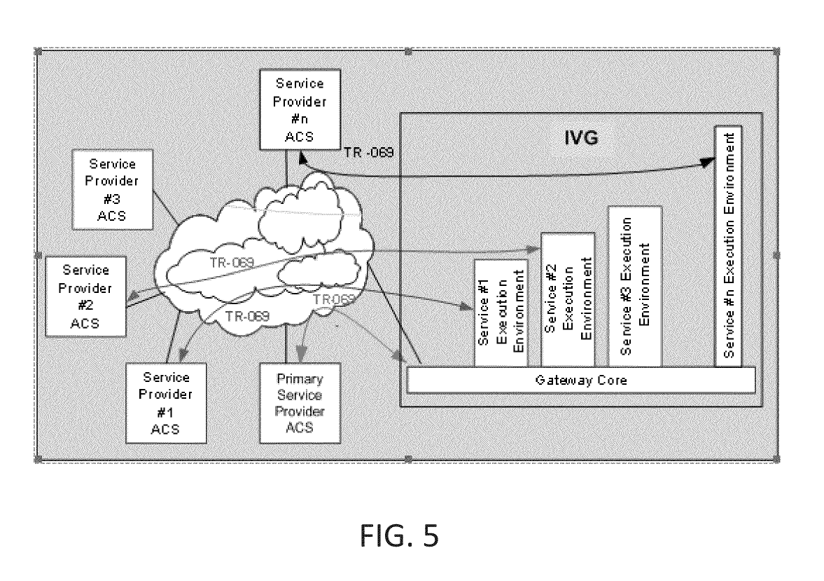

FIG. 5 is a block diagram of management and administration of intelligent virtual gateways, in accordance with some embodiments. The FIG. 5 illustrates an embodiment for managing and administering the individual virtual machines within an IVG using popular management software. The standard is called TR069 and this standard has been widely adopted by the telecommunication service providers as well system vendors. The salient feature of the scheme is that the server of each service provider can create a Service VM, replace a running Service VM with an updated version and diagnose issues with a service VM all on the fly. The Server relies on cooperation of the Admin VM within an IVG to carry out these tasks. Each Service VM can thus be managed individually without interfering with the operation of other Service VMs.

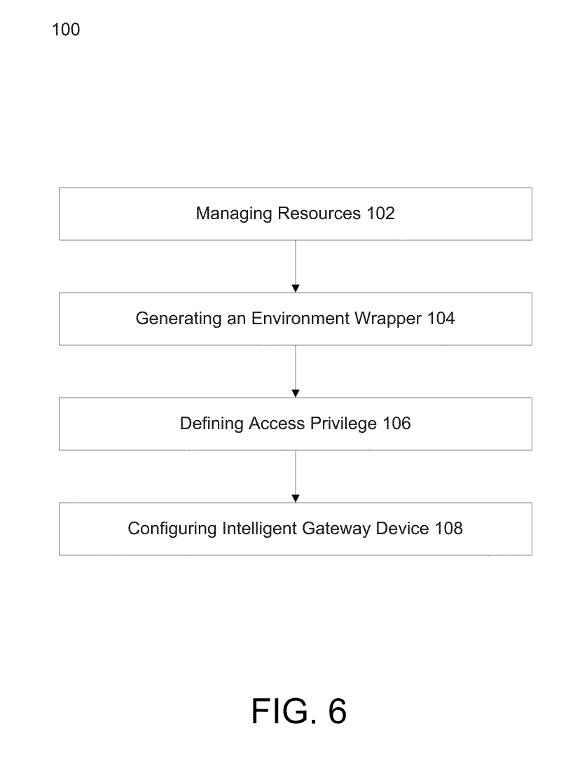

FIG. 6 is a flowchart of a method 100 for providing services in a secure way with guaranteed service and device level performance, in accordance with some embodiments. Embodiments of the method 100 include managing, by an intelligent gateway module on an intelligent gateway device, one or more internal resources and one or more external resources, as shown in block 102. The method 100 further includes generating, by the intelligent gateway module on an intelligent gateway device, an environment wrapper, as shown in block 104. In addition, the method 100 includes defining, by the environment wrapper, access privilege to a subset of the one or more internal resources and a subset of one or more external resources, as shown in block 106. Also, the method 100 includes configuring, by a personal cloud computer server coupled to the intelligent gateway device, the intelligent gateway device with a system load and configuration information as described herein, as shown in block 108.

The personal cloud server and the intelligent gateway device combination provides traditional services, and Internet of Things (IoT) services, and a secure premises environment such that traditional services, Internet of Things (IoT) services and secure premises environment are accessible from at least one of a remote location and a premises location. The intelligent gateway device is coupled to one or more internal interfaces, each internal interface corresponding to an internal resource, and one or more external interfaces, each external internal interface corresponding to an external resource. The intelligent gateway module includes, as described herein, at least one of: (a) one or more virtual machine modules; (b) a common security layer module; (c) privilege descriptor module; (d) virtualizer module; (e) a process container module; (f) an application module. The one or more internal resources include at least one of a printer, television, video disc player, computer, smartphone, tablet, scanner, networked storage, surveillance camera, networked vehicle, sensor and appliance. The one or more external resources include at least one of a cloud storage, an external computing service, software as a service, external platform as a service, information technology services and other intelligent gateway devices. The intelligent gateway module includes a guest user access sub-module and a configurable guest environment wrapper defining guest access privilege to a subset of the one or more internal resources and a subset of one or more external resources. A guest intelligent gateway device is coupled to the personal cloud computer server including a guest intelligent gateway module generated by the guest gateway device based on the system load and instructions received from the personal cloud computer server wherein the instructions are based on the configuration information of the intelligent gateway module such that the guest intelligent gateway module manages at least the subset of one or more internal resources available locally and a subset of one or more external resources accessible to intelligent gateway device. At least one of intelligent gateway module and guest intelligent gateway module manages at least one of privacy and security based on at least one of a device level and service level service agreement both of which as described herein.

Note the term intelligent gateway and intelligent virtual gateway may be interchangeable in the present disclosure.

Further embodiments may include a platform as a service (PaaS) as an external resource. PaaS is a category of cloud computing services that provides a computing platform and a solution stack as a service. PaaS offerings facilitate the deployment of applications or services without the cost and complexity of buying and managing the underlying hardware and software and provisioning hosting capabilities. Other embodiments may include software as a service (SaaS) and may be an external resource which is a software licensing and delivery model in which software is licensed on a subscription basis and is centrally hosted. It is sometimes referred to as “on-demand software”. It is also considered to be part of the nomenclature of cloud computing. Additional embodiments may include External Computing Resources which could be a Cloud facility like Amazon—This is referred as Infrastructure as a service (IaaS) and may be an external resource. In the most basic cloud-service model & according to the IETF (Internet Engineering Task Force), providers of IaaS offer computers—physical or (more often) virtual machines—and other resources. (A hypervisor, such as Xen, Oracle VirtualBox, KVM, VMware ESX/ESXi, or Hyper-V runs the virtual machines as guests.)

Embodiments of the disclosure includes a secure personal cloud (SPC) function implemented by one or more modules in a one or more personal cloud computer servers. Such an SPC function includes Mobility & WAN Security. Applications (Apps) on the mobile devices make requests to the personal cloud computer server to download a GUEST Intelligent gateway function and configuration information to the mobile device. The personal cloud computer server and the intelligent gateway function at the HOME location authenticates the request for downloading the GUEST gateway function and the configuration function. From this moment onwards, the GUEST intelligent gateway function in the mobile device function in similar way as the HOME intelligent gateway device. In some embodiments the internal and external interfaces may be different. and access privileges may be different

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for providing services in a secure way with guaranteed service and device level performance, the system comprising:
(a) an intelligent gateway device including:
(i) an intelligent gateway module for managing one or more internal resources and one or more external resources;
(ii) an environment wrapper defining access privilege to a subset of the one or more internal resources and a subset of one or more external resources;
(b) a personal cloud computer server coupled to the intelligent gateway device, the personal cloud computer server configuring the intelligent gateway device with a system load and configuration information;
wherein the personal cloud server and the intelligent gateway device combination provides traditional services, and Internet of Things (IoT) services, and a secure premises environment such that traditional services, Internet of Things (IoT) services and secure premises environment are accessible from at least one of a remote location and a premises location.

2. The system of claim 1, wherein intelligent gateway device is coupled to one or more internal interfaces, each internal interface corresponding to an internal resource, and one or more external interfaces, each external internal interface corresponding to an external resource.

3. The system of claim 1, wherein the intelligent gateway module includes at least one of:
(a) one or more virtual machine modules;
(b) a common security layer module;
(c) privilege descriptor module;
(d) virtualizer module;
(e) a process container module;
(f) an application module.

4. The system of claim 1, wherein the one or more internal resources include at least one of a printer, television, video disc player, computer, smartphone, tablet, scanner, networked storage, surveillance camera, networked vehicle, sensor and appliance.

5. The system of claim 1, wherein the one or more external resources include at least one of a cloud storage, an external computing service, software as a service, external platform as a service, information technology services and other intelligent gateway devices.

6. The system of claim 6, wherein the intelligent gateway module includes a guest user access sub-module and a configurable guest environment wrapper defining guest access privilege to a subset of the one or more internal resources and a subset of one or more external resources.

7. The system of claim 2, further comprising a guest intelligent gateway device coupled to the personal cloud computer server including:
a guest intelligent gateway module generated by the guest gateway device based on the system load and instructions received from the personal cloud computer server wherein the instructions are based on the configuration information if the intelligent gateway module such that the guest intelligent gateway module manages at least the subset of one or more internal resources available locally and a subset of one or more external resources accessible to intelligent gateway device.

8. The system of claim 7, wherein the at least one of intelligent gateway module and guest intelligent gateway module manages at least one of privacy and security based on at least one of a device level and service level service agreement using the intelligent gateway device.

9. A method for providing services in a secure way with guaranteed service and device level performance, the method comprising:
(a) managing, by an intelligent gateway module on an intelligent gateway device, one or more internal resources and one or more external resources;
(b) generating, by the intelligent gateway module on an intelligent gateway device, an environment wrapper;
(c) defining, by the environment wrapper, access privilege to a subset of the one or more internal resources and a subset of one or more external resources;
(d) configuring, by a personal cloud computer server coupled to the intelligent gateway device, the intelligent gateway device with a system load and configuration information wherein the personal cloud server and the intelligent gateway device combination provides traditional services, and Internet of Things (IoT) services, and a secure premises environment such that traditional services, Internet of Things (IoT) services and secure premises environment are accessible from at least one of a remote location and a premises location.

10. The method of claim 9, wherein intelligent gateway device is coupled to one or more internal interfaces, each internal interface corresponding to an internal resource, and one or more external interfaces, each external internal interface corresponding to an external resource.

11. The method of claim 9, wherein the intelligent gateway module includes at least one of:
(a) one or more virtual machine modules;
(b) a common security layer module;
(c) privilege descriptor module;
(d) virtualizer module;
(e) a process container module;
(f) an application module.

12. The method of claim 9, wherein the one or more internal resources include at least one of a printer, television, video disc player, computer, smartphone, tablet, scanner, networked storage, surveillance camera, networked vehicle, sensor and appliance.

13. The method of claim 9, wherein the one or more external resources include at least one of a cloud storage, an external computing service, software as a service, external platform as a service, information technology services and other intelligent gateway devices.

14. The method of claim 11, wherein the intelligent gateway module includes a guest user access sub-module and a configurable guest environment wrapper defining guest access privilege to a subset of the one or more internal resources and a subset of one or more external resources.

15. The method of claim 10, wherein a guest intelligent gateway device is coupled to the personal cloud computer server including:
a guest intelligent gateway module generated by the guest gateway device based on the system load and instructions received from the personal cloud computer server wherein the instructions are based on the configuration information of the intelligent gateway module such that the guest intelligent gateway module manages at least the subset of one or more internal resources available locally and a subset of one or more external resources accessible to intelligent gateway device.

16. The method of claim 15, wherein the at least one of intelligent gateway module and guest intelligent gateway module manages at least one of privacy and security based on at least one of a device level and service level service agreement.

17. A personal cloud computer server device for providing services in a secure way with guaranteed service and device level performance, the personal cloud server device comprising:
(a) one or more processors;
(b) one or more storage devices coupled to the one or more processors;
(c) one or more modules, implemented by one or more processors, including a personal cloud computer server module coupled to an intelligent gateway device, the personal cloud computer server module configuring the intelligent gateway device with a system load and configuration information;
wherein the personal cloud computer server device and the intelligent gateway device combination provides traditional services, and Internet of Things (IoT) services, and a secure premises environment such that traditional services, Internet of Things (IoT) services and secure premises environment are accessible from at least one of a remote location and a premises location.

18. The personal cloud computer server device of claim 17, wherein intelligent gateway device is coupled to one or more internal interfaces, each internal interface corresponding to an internal resource, and one or more external interfaces, each external internal interface corresponding to an external resource.

19. The personal cloud computer server device of claim 18, wherein:
the one or more internal resources include at least one of a printer, television, video disc player, computer, smartphone, tablet, scanner, networked storage, surveillance camera, networked vehicle, sensor and appliance;
the one or more external resources include at least one of a cloud storage, an external computing service, software as a service, external platform as a service, information technology services and other intelligent gateway devices.

20. The personal cloud computer server device of claim 18, wherein the personal cloud computer server module provides and the system load instructions to a guest intelligent gateway module on a guest intelligent gateway module device wherein the instructions are based on the configuration information if the intelligent gateway module such that the guest intelligent gateway module manages at least the subset of one or more internal resources available locally and a subset of one or more external resources accessible to intelligent gateway device.
